(19) United States
(12) Patent Application Publication
(10) Pub. No.: US 2017/0102049 A1
(43) Pub. Date: Apr. 13, 2017

(54) TRANSMISSION BELT

(71) Applicant: BANDO CHEMICAL INDUSTRIES, LTD., Kobe-shi (JP)

(72) Inventors: Kimichika Ohno, Kobe-shi (JP); Hiroyuki Tachibana, Kobe-shi (JP)

(21) Appl. No.: 15/383,916

(22) Filed: Dec. 19, 2016

Related U.S. Application Data
(63) Continuation of application No. PCT/JP2015/002830, filed on Jun. 4, 2015.

(30) Foreign Application Priority Data
Jun. 18, 2014 (JP) 2014-125668

(51) Int. Cl. F16G 5/08; C08K 5/09; C08K 3/22; C08K 3/04

(52) U.S. Cl. CPC F16G 5/08; C08K 3/04; C08K 5/09; C08K 3/22; C08K 2003/2296

(57) ABSTRACT

A wrapped V-belt B is wrapped around a pulley to transmit power, and includes a belt body, and a reinforcing cloth wrapping the belt body. At least part of the belt body is made of a rubber composition containing ethylene-α-olefin elastomer as a polymer component. The polymer component contains the ethylene-α-olefin elastomer within a range of 30 to 100% by mass, in which an ethylene content falls within a range of 40 to 56% by mass.

### CROSS-REFERENCE TO RELATED APPLICATIONS

This is a continuation of International Application No. PCT/JP2015/002830 filed on Jun. 4, 2015, which claims priority to Japanese Patent Application No. 2014-125668 filed on Jun. 18, 2014. The entire disclosures of these applications are hereby incorporated by reference.

### BACKGROUND

The present disclosure relates to power transmission belts used for agricultural machines, general industrial machines, and other machines.

Power transmission belts are used widely to transmit power in agricultural machines, general industrial machines, and other machines. Power transmission belts need to have various characteristics. For example, Japanese Unexamined Patent Publication No. 2001-82548 defines the contents of ethylene, diene, and other components to provide a power transmission belt highly resistant to bending fatigue and heat.

Waste molded rubber products and scrap vulcanized rubber generated during the manufacture of molded rubber products are devulcanized to be used as devulcanized reclaimed rubber, which may also be a material of power transmission belts.

### SUMMARY

Manufactured power transmission belts need to have various characteristics. In addition, manufacture of power transmission belts requires high workability of materials. In this respect, a power transmission belt according to Japanese Unexamined Patent Publication No. 2001-82548 has low workability (e.g., tackiness), and thus, excessive air tends to enter the gap between rubber sheets being layered in belt formation. Once entered, the air might remain between the rubber sheets even after vulcanization, which may result in unreliable quality of the belt, or may hinder the manufacture of the belt itself in the case where the belt is a wrapped V-belt.

In view of these problems, a technique for producing a power transmission belt with high resistance to abrasion and high workability will now be described.

The present inventors thought of using a highly fluid rubber composition to produce tacky rubber and, for this purpose, of reducing crystallinity caused by ethylene chains.

Specifically, a wrapped V-belt according to the present disclosure is wrapped around a pulley to transmit power, and includes a belt body; and a reinforcing cloth wrapping the belt body. At least part of the belt body is made of a rubber composition containing ethylene-α-olefin elastomer as a polymer component. The polymer component contains the ethylene-α-olefin elastomer within a range of 30 to 100% by mass, in which an ethylene content falls within a range of 40 to 56% by mass.

At least one surface of the reinforcing cloth may be coated with a rubber composition containing a resin component within a range of 1 to 20% by mass and oil within a range of 3 to 24% by mass.

The rubber composition containing the polymer component described above has lower crystallinity caused by ethylene chains, high fluidity, and high tackiness. Thus, with the use of such a rubber composition for forming a belt, for example, for forming a base and/or adhesive rubber layer(s), for rubber treatment of a reinforcing cloth, and for other purposes, a wrapped V-belt with sufficient workability and reliable quality is provided.

The belt body may include a base rubber layer on a side closer to a contact with the pulley. The base rubber layer may be made of the rubber composition containing devulcanized reclaimed ethylene propylene diene rubber.

If devulcanized reclaimed ethylene propylene diene monomer (EPDM) rubber is used, the rubber composition has a low tan δ value, which reduces generation of heat when the belt is bent, thereby providing a belt highly resistant to bending fatigue.

Devulcanization of vulcanized rubber containing a fiber component may melt the fiber component so that the devulcanized reclaimed ethylene propylene diene rubber serves as a material reinforcing the rubber composition.

The belt body may include a base rubber layer on a side closer to a contact with the pulley. The base rubber layer may be made of the rubber composition containing kneaded vulcanized rubber powder.

This configuration reduces the tan δ value at low costs.

At least one surface of the reinforcing cloth, which serves as an outer surface of the belt, is not subjected to rubber treatment.

As a result, a clean belt is produced which does not soil a machine including the belt and its surroundings.

A wrapped V-belt according to the present disclosure has reliable quality and improved performance. Wasted vulcanized rubber can be reclaimed to produce a belt.

### BRIEF DESCRIPTION OF THE DRAWINGS

FIG. 1 illustrates an exemplary power transmission belt according to an embodiment of the present disclosure.

FIGS. 2A-2G illustrate a method of manufacturing the power transmission belt of FIG. 1.

FIG. 3 illustrates how to test belts in experiments of the present disclosure.

### DETAILED DESCRIPTION

An embodiment of the present disclosure will now be described with reference to the drawings.

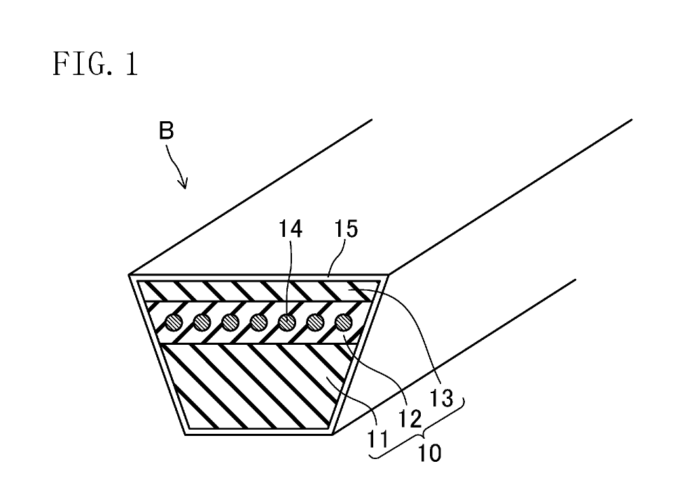

FIG. 1 illustrates an exemplary V-belt (power transmission belt) B according to this embodiment. The V-belt B is used for an agricultural or industrial machine, for example. Although the size of the V-belt B is not particularly limited, the V-belt B may have, for example, a perimeter of 700-5000 mm, a width of 16-17 mm, and a thickness of 8-10 mm.

The V-belt B includes a belt body 10, which is a triple layer of a base rubber layer 11, an adhesive rubber layer 12, and a back rubber layer 13. The base rubber layer 11 is disposed on the inner periphery of the belt (on the side closer to the contact with a pulley). The adhesive rubber layer 12 is an intermediate layer. The back rubber layer 13 is disposed on the outer periphery of the belt. A cord 14 is embedded in the adhesive rubber layer 12 so as to form a spiral with a pitch along the width of the belt.

The entire belt body 10 is wrapped with a reinforcing cloth 15 so that the V-belt B is a wrapped belt.

The base rubber layer 11 is made of a rubber composition, in which a polymer component contains ethylene-α-olefin elastomer. The polymer component also contains polymer within a range of 30 to 100% by mass. The ethylene content of the polymer component falls within a range of 40 to 56% by mass. Such a rubber composition has low crystallinity caused by ethylene chains and high fluidity, thereby exhibiting high tackiness. The rest of the polymer component (i.e., 0-70% by mass) is, for example, ethylene-α-olefin elastomer with an ethylene content out of the range of 40 to 56% by mass.

The rubber composition forming the base rubber layer 11 may contain devulcanized reclaimed EPDM. Such EPDM has a low tan δ value so as to reduce heat generation in bending the belt so that the belt is highly resistant to bending fatigue. Furthermore, use of devulcanized rubber, which is obtained by devulcanizing vulcanized rubber containing a fiber component, improves the durability and other performance, since the fiber component melts so that the devulcanized rubber serves as a material reinforcing the rubber composition.

The devulcanized reclaimed rubber is obtained by extracting cross-linked rubber (or a cross-linked rubber composition) from a used rubber product, and devulcanizing the cross-linked rubber by a predetermined method. Specifically, cross-linked rubber containing sulfur cross-linked EPDM is pulverized into powder or particles in advance, and devulcanized as the powder or particles by applying shear stress at a predetermined processing temperature. Part of cross-linking points and main chains of EPDM are broken so that the devulcanized reclaimed rubber obtained in this manner contains cross-linkable EPDM and a gel part of EPDM as elastic rubber provided by the remaining sulfur crosslinking points. As a result, the rubber composition containing the devulcanized reclaimed rubber has higher rubber elasticity and a lower tan δ value than the rubber composition only containing virgin rubber. Examples of used rubber products include power transmission belts, conveyor belts, tires, and hoses.

The average particle size of the cross-linked rubber as the powder or particles is, for example, equal to or larger than 10 μm (more specifically, equal to or larger than 100 μm) and equal to or smaller than 5 mm (more specifically, equal to or smaller than 3 mm). The particle size of the cross-linked rubber is measured using a microscope (e.g., No. VHX2000 of KEYENCE in a measuring mode).

The devulcanization temperature is, for example, equal to or higher than 150° C. (more specifically, equal to or higher than 180° C.) and equal to or lower than 250° C. (more specifically, equal to or lower than 230° C.) to balance the devulcanized part and the remaining gel part. The shear stress in devulcanization is, for example, equal to or higher than 0.981 MPa (more specifically, equal to or higher than 4 MPa) and equal to or lower than 20 MPa (more specifically, equal to or lower than 15 MPa) to balance the devulcanized part and the remaining gel part. The time for devulcanization depends on the balance between the devulcanized part and the remaining gel part, and the size of a processor.

The devulcanization described above may be performed using known processing equipment such as a single or double screw extruder.

The rubber composition forming the base rubber layer 11 may be produced by mixing vulcanized rubber powder into virgin rubber when kneaded.

The vulcanized rubber powder is, for example, powder of sulfur cross-linked EPDM. The diameter of the vulcanized rubber powder is, for example, equal to or larger than 1 μm (more specifically, 20 μm) and equal to or smaller than 1000 μm (more specifically, 300 μm).

The vulcanized rubber powder is agglomerated, and has the size described above as an aggregate before being mixed. However, after being mixed with the virgin rubber and kneaded, the diameter of the aggregate decreases to, for example, equal to or larger than 0.1 μm (more specifically, equal to or larger than 1 μm) and equal to or smaller than 300 (more specifically, equal to or smaller than 200 μm).

The vulcanized rubber powder is obtained by pulverizing cross-linked rubber containing sulfur cross-linked EPDM, for example. Alternatively, rubber powder left after cutting cross-linked rubber in manufacturing power transmission belts may be used. In this case, waste rubber powder can be reused, which leads to reduction in material costs.

The adhesive rubber layer 12 may also be made of the above rubber composition.

Furthermore, at least one surface of the reinforcing cloth 15 may be wrapped with the rubber composition. In this case, the content of the rubber composition wrapping the reinforcing cloth 15 is, for example, equal to or greater than 1% by mass (more specifically, equal to or greater than 5% by mass) and equal to or smaller than 20% by mass (more specifically, equal to or smaller than 10% by mass). The oil content of the rubber composition is, for example, equal to greater than 3% by mass (more specifically, equal to greater than 5% by mass) and equal to smaller than 24% by mass (more specifically, equal to smaller than 12% by mass). Due to these contents, the rubber has high workability and high resistance to abrasion.

The side of the reinforcing cloth 15, which serves as the outer surface of the belt, is not necessarily wrapped with any rubber composition. This results in formation of a clean belt that does not soil a machine including the belt and its surroundings without significantly degrading the performance as compared to a belt including a reinforcing cloth 15 with both sides coated with a rubber composition.

The rubber composition contains a polymer component and other compounding ingredients mixed with the polymer component. The other compounding ingredients are, for example, a reinforcing material such as carbon black, a vulcanization accelerator, a vulcanization accelerator aid, a crosslinker, an antioxidant, and a softener.

Examples of carbon black used as the reinforcing material include channel black, furnace black such as SAF, ISAF, N-339, HAF, N-351, MAF, FEF, SRF, GPF, ECF and N-234, thermal black such as FT and MT, and acetylene black. Silica may as well serve as a reinforcing material. The reinforcing material may be composed of a single kind or multiple kinds. The amount of reinforcing material mixed with 100 parts by mass of the rubber component ranges from, for example, from 30 to 80 parts by mass to balance the resistance to abrasion and the resistance to bending.

Examples of the vulcanization accelerator include thiazole-based compounds (e.g., MBT and MBTS), thiuram-based compounds (e.g., TT and TRA), sulfenamide compounds (e.g., CZ), and dithiocarbamate based compounds (e.g., BZ-P). The vulcanization accelerator may be composed of a single kind or multiple kinds. If the crosslinker is sulfur, the vulcanization accelerator may also be added. In this case, both the thiazole-based vulcanization accelerator and thiuram-based vulcanization accelerator may be used. The amount of vulcanization accelerator mixed with 100 parts by mass of the rubber component of the rubber composition ranges, from 0.5 to 10 parts by mass, for example.

Examples of the vulcanization accelerator aid include metal oxide such as magnesium oxide and zinc oxide (flowers of zinc), metal carbonate, fatty acid such as stearic acid, and derivatives thereof. The vulcanization accelerator aid may be composed of a single kind or multiple kinds. The amount of vulcanization accelerator aid mixed with 100 parts by mass of the rubber component ranges, from 0.5 to 8 parts by mass, for example.

Examples of the crosslinker include sulfur and organic peroxide. Sulfur and organic peroxide may be used as the crosslinker either alone or in combination. If the crosslinker is made of sulfur, the amount of crosslinker mixed with 100 parts by mass of the material rubber ranges from, for example, from 0.5 to 4.0 parts by mass. If the crosslinker is made of organic peroxide, the crosslinker mixed with 100 parts by mass of the material rubber ranges from 0.5 to 8 parts by mass, for example.

Examples of the organic peroxide include dialkyl peroxides such as dicumyl peroxide, peroxy esters such as t-butyl peroxyacetate, and ketone peroxides such as dicyclohexanone peroxide. Organic peroxide may be composed of a single kind or multiple kinds.

Examples of the antioxidant include amine-based antioxidant, quinoline-based antioxidant, hydroquinone derivative, phenol-based antioxidant, and phosphite-ester-based antioxidant. The antioxidant may be composed of a single kind or multiple kinds. The amount of antioxidant mixed with 100 parts by mass of the material rubber ranges from 0 to 8 parts by mass, for example.

Examples of the softener include petroleum-based softener, paraffinum-liquidum-based softener such as paraffin wax, and vegetable-oil-based softener such as castor oil, cottonseed oil, linseed oil, rapeseed oil, soybean oil, palm oil, coconut oil, peanut oil, sumach wax, rosin, and pine oil. The softener may be composed of a single kind or multiple kinds. The amount of softener, other than the petroleum-based softener, mixed with 100 parts by mass of the material rubber ranges from 2 to 30 parts by mass, for example.

The rubber composition may also contain layered silicate of a smectite group, a vermiculite group, a kaolin group, and other groups as the compounding ingredients.

The rubber for coating the reinforcing cloth 15 may contain a material reducing the coefficient of friction. Examples of the material reducing the coefficient of friction include short fibers such as short nylon fibers, short vinylon fibers, short aramid fibers, short polyester fibers, and short cotton fibers, and ultrahigh molecular weight polyethylene resin.

Each of the adhesive rubber layer 12 and the back rubber layer 13 is like a band with a longitudinally elongated rectangular cross-section. Each of the adhesive rubber layer 12 and the back rubber layer 13 is made of a rubber composition obtained as follows. An uncross-linked rubber composition containing a material rubber that is mixed and kneaded together with various kinds of compounding ingredients. The uncross-linked rubber composition is then heated, pressurized, and cross-linked by a crosslinker to become the rubber composition.

The rubber component of the rubber composition forming the adhesive rubber layer 12 and the back rubber layer 13 may be the same EPDM as the base rubber layer 11. Alternatively, other rubber compositions such as ethylene-α-olefin elastomer, chloroprene rubber (CR), chlorosulfonated polyethylene rubber (CSM), and hydrogenated acrylonitrile rubber (H-NBR) may be used.

Like the base rubber layer 11, examples of the compounding ingredients include a reinforcing material such as carbon black, a vulcanization accelerator, a crosslinker, an antioxidant, and a softener.

The cord 14 is formed of a twisted yarn made of polyester (PET) fibers, polyethylene naphthalate (PEN) fibers, aramid fibers, vinylon fiber, or any other fiber. The cord 14 is subjected to adhesion treatment to become adhesive to the belt body 10. As the adhesion treatment, the cord 14 may be immersed into an RFL solution before molding, and then heated. Additionally or alternatively, the cord 14 may be immerged into rubber cement and then dried.

The reinforcing cloth 15 is a woven, knitted, or non-woven cloth made of yarns such as cotton, polyamide fibers, polyester fibers, or aramid fibers. The reinforcing cloth 15 is subjected to adhesion treatment to become adhesive to the belt body 10. As the adhesion treatment, the reinforcing cloth 15 may be immerged into RFL solution before molding, and then heated. Additionally or alternatively, the surface of the reinforcing cloth 15 facing the belt body 10 may be coated with rubber cement and then dried.

### Method of Manufacturing Power Transmission Belt

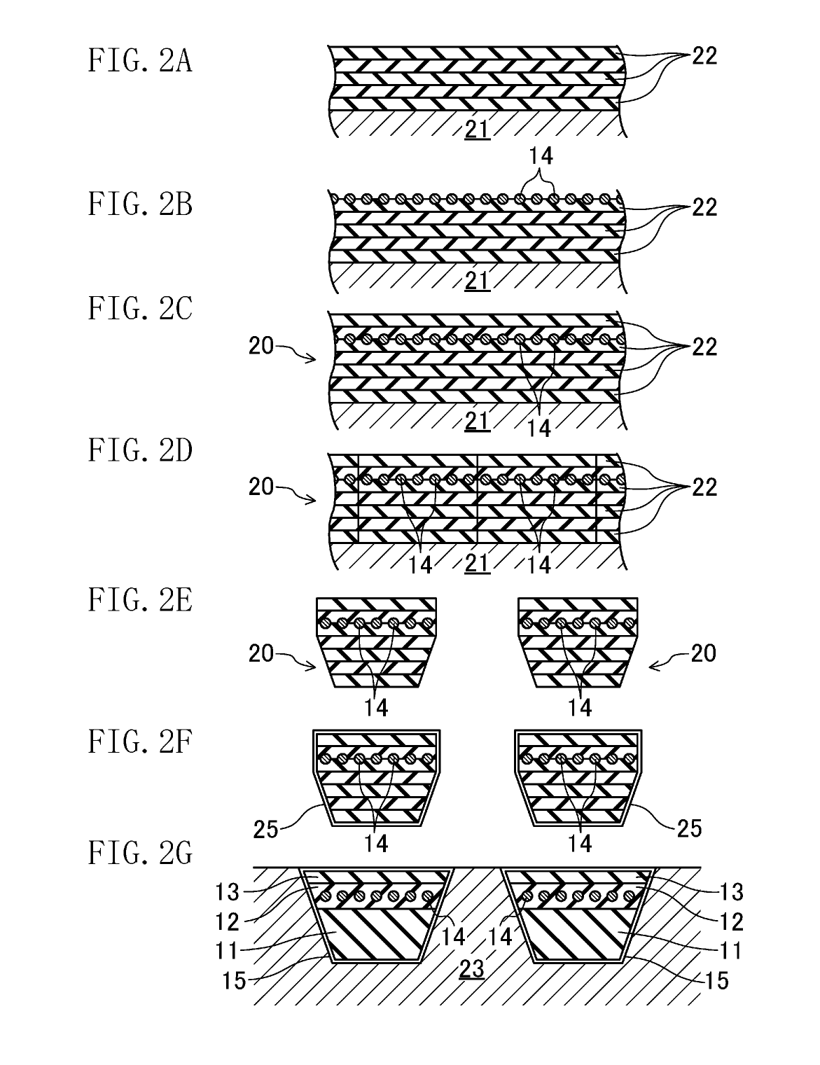

A method of manufacturing the V-belt B, which is a wrapped V-belt, will now be described with reference to FIGS. 2A-2G.

First, rubber sheets 22 for a compressed rubber layer, an adhesive rubber layer, and an extension rubber layer are prepared. The rubber sheets 22 are obtained by processing the uncross-linked rubber composition, which has been described in the embodiment, into sheets using a calendar roll, for example. The twisted yarn 14 for the cord and the cloth for the reinforcing cloth 15 are subjected to adhesion treatment.

Next, as shown in FIG. 2A, the rubber sheet 22 for the compressed rubber layer made of a chloroprene rubber composition, for example, is wrapped multiple times around a mantle 21. Then, the rubber sheet 22 for the adhesive rubber layer is wrapped on the rubber sheet 22 for the compressed rubber layer. Furthermore, as shown in FIG. 2B, the cord (e.g., polyester cord) 14 with an adhesive is wound spirally around the rubber sheets 22. As shown in FIG. 2C, the rubber sheets 22 for the adhesive rubber layer and the back rubber layer are wrapped around the cord. As a result, a cylindrical multilayer 20 is obtained.

Next, as shown in FIG. 2D, the cylindrical multilayer 20 is sliced on the mantle 21 into rings with a predetermined width, which are taken out of the mantle 21.

Then, as shown in FIG. 2E, each ring-shaped multilayer 20 is wrapped around a pair of pulleys with the thicker side of the rubber layers facing the outside. Two lower edges of the ring-shaped multilayer 20 are cut diagonally while the ring-shaped multilayer 20 rotates. The ring-shaped multilayer 20 is skived into a V-shaped cross section. This skiving adjusts the volume of the ring-shaped multilayer 20.

After that, as shown in FIG. 2F, a cloth 25 for belt formation, which serves as the reinforcing cloth 15, is wrapped around the outer periphery of the ring-shaped multilayer 20, which has been skived into the V-shaped cross-section.

As shown in FIG. 2G, the wrapped ring-shaped multilayer 20 is fitted to the outer periphery of a cylindrical mold 23. The whole cylindrical mold 23 is put into a vulcanizer and heated and pressurized. The rubber components of the ring-shaped multilayer 20 cross-link and combine so that the cloth 25 for belt formation serves as the reinforcing cloth 15. As a result, the V-belt B being a wrapped V-belt is manufactured.

### EXPERIMENTS

### First Experiment

A first experiment will now be described. In this experiment, rubber compositions A-L used for the base rubber layer 11, the adhesive rubber layer 12, and friction rubber, which is used as rubber for coating the reinforcing cloth 15, were prepared. These rubber compositions were used to produce wrapped V-belts according to Examples 1-8 and Comparative Examples 1-5. In addition, a typical wrapped chloroprene V-belt was prepared as Comparative Example 6.

### Rubber Compositions

Table 1 shows the amounts of components of the rubber compositions A-E and H-L used for the adhesive rubber layer 12 and the friction rubber. Table 2 shows the amounts of components of the rubber compositions A, H, F, and G used for the base rubber layer 11. The amounts of components of the rubber compositions A of Tables 1 and 2 are the same. Both the tables also show resin and oil fractions calculated based on the respective amounts. The compositions will be described below.

### Rubber Composition A

EPDM with an ethylene (C2) content of 52% by mass (e.g., EP33 manufactured by JSR Corporation) was used as the rubber component. The amounts of compounding ingredients mixed with 100 parts by mass of EPDM were as follows. The amount of HAF carbon black (e.g., SEAST 3 manufactured by Tokai Carbon Co., Ltd.) was 50 parts by mass. The amount of stearic acid (e.g., stearic acid beads Tsubaki manufactured by NOF Corporation) was 1 parts by mass. The amount of zinc oxide (e.g., zinc oxide No. 3 manufactured by Sakai Chemical Industry Co., Ltd.) was 5 parts by mass. The amount of a resin component (e.g., Quinton A100 manufactured by Nippon Zeon Co., Ltd.) was 10 parts by mass. The amount of oil (e.g., Diana Process PW-90 manufactured by Idemitsu Kosan Co., Ltd.) was 20 parts by mass. The amount of sulfur (e.g., sulfur for oil treatment manufactured by Karuizawa Seirensho) was 3 parts by mass. The amount of an accelerator 1, which is a thiuram-based compound vulcanization accelerator (e.g., Nocceler TET manufactured by Ouchi Shinko Chemical Industrial Co., Ltd.) was 2 parts by mass. The amount of an accelerator 2, which is a thiazole-based vulcanization accelerator (e.g., Nocceler DM-P manufactured by Ouchi Shinko Chemical Industrial Co., Ltd.) was 1 parts by mass. As a result of kneading these ingredients, the rubber compositions A of Table 1 and Table 2 were obtained.

### Rubber Composition B

Among the ingredients of the rubber composition A, only the resin content was reduced from 10 to 2 parts by mass. As a result of kneading these ingredients, the rubber composition B of Table 1 was obtained.

### Rubber Composition C

Among the ingredients of the rubber composition A, only the resin content was increased from 10 to 42 parts by mass. As a result of kneading these ingredients, the rubber composition C of Table 1 was obtained.

### Rubber Composition D

Among the ingredients of the rubber composition A, only the oil content was reduced from 20 to 6 parts by mass. As a result of kneading these ingredients, the rubber composition D of Table 1 was obtained.

### Rubber Composition E

Among the ingredients of the rubber composition A, only the oil content was increased from 20 to 50 parts by mass. As a result of kneading these ingredients, the rubber composition E of Table 1 was obtained.

### Rubber Composition F

Among the ingredients of the rubber composition A, 100 parts by mass of EP33 as the rubber component were replaced with 200 parts by mass of devulcanized rubber. The devulcanized rubber had been obtained for reclaim by devulcanizing vulcanized EP33 that contains no fiber. As will be described later, this devulcanized rubber contained 50% by mass of EPDM, the amount of which was 100 parts by mass. No HAF carbon was added. The other ingredients were as the same as those of the rubber composition A. As a result of kneading these ingredients, the rubber composition F of Table 2 was obtained.

### Rubber Composition G

Among the ingredients of the rubber composition A, 100 parts by mass of EP33 as the rubber component was replaced with 200 parts by mass of devulcanized rubber. The devulcanized rubber had been obtained for reclaim by devulcanizing vulcanized EP33 that contains fibers. This devulcanized rubber also contained 50% by mass of EPDM, the amount of which was 100 parts by mass. No HAF carbon was added. The other ingredients were as the same as those of the rubber composition A. As a result of kneading these ingredients, the rubber composition G of Table 2 was obtained. In other words, the rubber composition G contains the same ingredients as the rubber composition F other than the devulcanized rubber, which had been obtained for reclaim by devulcanizing vulcanized EPDM containing the fibers.

### Rubber Composition H

Among the ingredients of the rubber composition A, 100 parts by mass of EPDM (EP33), as the rubber component, with an ethylene content of 52% by mass were replaced with 100 parts by mass of EPDM (e.g., EP51 manufactured by JSR Corporation) with an ethylene content of 67% by mass. The other ingredients were as the same as those of the rubber composition A. As a result of kneading these ingredients, the rubber composition H of Table 2 was obtained.

### Rubber Composition I

Among the ingredients of the rubber composition A, only the resin content was reduced from 10 to 1.5 parts by mass. As a result of kneading these ingredients, the rubber composition I of Table 1 was obtained.

### Rubber Composition J

Among the ingredients of the rubber composition A, only the resin content was increased from 10 to 47 parts by mass. As a result of kneading these ingredients, the rubber composition J of Table 1 was obtained.

### Rubber Composition K

Among the ingredients of the rubber composition A, only the oil content was reduced from 20 to 4 parts by mass. As a result of kneading these ingredients, the rubber composition K of Table 1 was obtained.

### Rubber Composition L

Among the ingredients of the rubber composition A, only the oil content was increased from 20 to 55 parts by mass. As a result of kneading these ingredients, the rubber composition L of Table 1 was obtained.

### Devulcanized Rubber

The devulcanized rubber used for the rubber compositions F and G was obtained as follows.

Specifically, two types of EPDM compositions cross-linked by sulfur were prepared. Both types contained 50% by mass of EPDM as the rubber component. One contained fibers, and the other contained no fiber. The cross-linked rubber was pulverized into powder or particles with an average particle size of 150 μm, and then put into a twin-screw extruder (No. TEX 30α manufactured by The Japan Steel Works, LTD. with a screw diameter of 30 mm and a screw length of 1785 mm). The cross-linked rubber in the form of powder or particles was subjected to shear stress to be devulcanized, and then cooled to become reclaimed rubber.

TABLE 1

| | A | B | C | D | E | H | I | J | K | L |
|---|---|---|---|---|---|---|---|---|---|---|
| EP33 | 100 | 100 | 100 | 100 | 100 | | 100 | 100 | 100 | 100 |
| EP51 | | | | | | 100 | | | | |
| HAF Carbon Black | 50 | 50 | 50 | 50 | 50 | 50 | 50 | 50 | 50 | 50 |
| Stearic Acid | 1 | 1 | 1 | 1 | 1 | 1 | 1 | 1 | 1 | 1 |
| Zinc Oxide | 5 | 5 | 5 | 5 | 5 | 5 | 5 | 5 | 5 | 5 |
| Resin | 10 | 2 | 42 | 10 | 10 | 10 | 1.5 | 47 | 10 | 10 |
| Oil | 20 | 20 | 20 | 6 | 50 | 20 | 20 | 20 | 4 | 55 |
| Sulfur | 3 | 3 | 3 | 3 | 3 | 3 | 3 | 3 | 3 | 3 |
| Accelerator 1 | 2 | 2 | 2 | 2 | 2 | 2 | 2 | 2 | 2 | 2 |
| Accelerator 2 | 1 | 1 | 1 | 1 | 1 | 1 | 1 | 1 | 1 | 1 |
| Sum | 192 | 184 | 224 | 178 | 222 | 192 | 183.5 | 229 | 176 | 227 |
| Resin Fraction (% by | 5.2 | 1.1 | 18.8 | 5.6 | 4.5 | 5.2 | 5.2 | 20.5 | 5.7 | 4.4 |
| mass) | | | | | | | | | | |
| Oil Fraction (% by | 10.4 | 10.9 | 8.9 | 3.4 | 22.5 | 10.4 | 10.4 | 8.7 | 2.3 | 24.2 |
| mass) | | | | | | | | | | |

TABLE 2

| | A | H | F | G |
|---|---|---|---|---|
| EP33 | 100 | | | |
| EP51 | | 100 | | |
| Devulcanized Product | | | 200 | |
| (Former Rubber without | | | | |
| Fibers) | | | | |
| Devulcanized Product | | | | 200 |
| (Former Rubber with | | | | |
| Fibers) | | | | |
| HAF Carbon Black | 50 | 50 | | |
| Stearic Acid | 1 | 1 | 1 | 1 |
| Zinc Oxide | 5 | 5 | 5 | 5 |
| Resin | 10 | 10 | 10 | 10 |
| Oil | 20 | 20 | 20 | 20 |
| Sulfur | 3 | 3 | 3 | 3 |
| Accelerator 1 | 2 | 2 | 2 | 2 |
| Accelerator 2 | 1 | 1 | 1 | 1 |
| Sum | 192 | 192 | 242 | 242 |
| Resin Fraction (% by | 5.2 | 5.2 | 4.1 | 4.1 |
| mass) | | | | |
| Oil Fraction (% by mass) | 10.4 | 10.4 | 8.3 | 8.3 |

### Dissipation Factor Tan δ

The uncross-linked rubber compositions of the examples and comparative examples were molded and vulcanized to obtain rubber sheets. The dissipation factors tan δ of the rubber sheets were determined at 100° C. in a grain direction at an oscillation frequency of 10 Hz and dynamic strain of 1.0% in accordance with JIS K6394.

### Fabrication of Wrapped V-Belt

Wrapped V-belts according to Examples 1-8 and Comparative Examples 1-5 were fabricated as shown in FIGS. 2A-2F using any one of the rubber compositions A-L as shown in Table 3 for the base rubber layer 11, the adhesive rubber layer 12, and the friction rubber. As described above, Comparative Example 6 was a typical wrapped V-belt made of chloroprene rubber.

As the base rubber layer 11, the composition A was used in Examples 1-5 and 8 and Comparative Examples 2-5. The rubber compositions F, G, and H were used as the base rubber layer 11 in Examples 6 and 7 and Comparative Example 1, respectively.

As the adhesive rubber layer 12, the rubber composition H was used in Comparative Example 1, while the rubber composition A was used in Examples 1-8 and Comparative Examples 2-5.

As the friction rubber, the rubber compositions A-E were used in Examples 1-5, respectively, the rubber composition A in Examples 6-8, and the rubber compositions H-L in Comparative Examples 1-5, respectively.

A “treatment surface” in Table 3 denotes the surface of the reinforcing cloth 15 coated with rubber. That is, with respect to the wrapped V-belt of Example 8, only the inner surface of the reinforcing cloth 15 was coated with the friction rubber, whereas the outer surface of the reinforcing cloth 15 was not coated. With respect to the other belts, that is, Examples 1-7 and Comparative Examples 1-6, both sides of the reinforcing cloth 15 were coated with the friction rubber.

TABLE 3

| | | Exam- | Exam- | Exam- | Exam- | Exam- | Exam- | Exam- |
|---|---|---|---|---|---|---|---|---|
| | | ple 1 | ple 2 | ple 3 | ple 4 | ple 5 | ple 6 | ple 7 |
| Polymer | Product | EP33 | EP33 | EP33 | EP33 | EP33 | Base | Base |
| | No. | | | | | | Rubber: | Rubber: |
| | or | | | | | | EP33 + | EP33 + |
| | Material | | | | | | Devul- | Devul- |
| | | | | | | | canized | canized |
| | | | | | | | Reclaimed | Reclaimed |
| | | | | | | | Rubber | Rubber |
| | C2 | 52 | 52 | 52 | 52 | 52 | — | — |
| | Content | | | | | | | |
| Friction | Composition Type | A | B | C | D | E | A | A |
| Rubber | Coated Surface(s) | Both | Both | Both | Both | Both | Both | Both |
| | Resin Content (% by mass) | 5.2 | 1.1 | 18.8 | 5.6 | 4.5 | 5.2 | 5.2 |
| | Oil Content (% by mass) | 10.4 | 10.9 | 8.9 | 3.4 | 22.5 | 10.4 | 10.4 |
| | Frictioning Characteristics | ○ | ○ | ○ | ○ | ○ | ○ | ○ |
| | Lap-joint Strength | ○ | ○ | ○ | ○ | ○ | ○ | ○ |
| | Covering Characteristics | ○ | ○ | ○ | ○ | ○ | ○ | ○ |
| Adhesive | Composition Type | A | A | A | A | A | A | A |
| Rubber | Adhisiveness to Cord | ○ | ○ | ○ | ○ | ○ | ○ | ○ |
| Base | Composition Type | A | A | A | A | A | F | G |
| Rubber | Ply-up Characteristics | ○ | ○ | ○ | ○ | ○ | ○ | ○ |
| | tan δ (100° C.) | 0.186 | 0.186 | 0.186 | 0.186 | 0.186 | 0.107 | 0.096 |
| Belt | Appearance/Size | ○ | ○ | ○ | ○ | ○ | ○ | ○ |
| | Life at Durable Test | 320 | 302 | 287 | 311 | 282 | 414 | 425 |
| | and Error Mode | (Crack in | (Crack in | (Great | (Crack in | (Great | (Crack in | (Crack in |
| | where CR is 100 | Base | Base | Abresion) | Base | Abresion) | Base | Base |
| | | Rubber) | Rubber) | | Rubber) | | Rubber) | Rubber) |
| | Degree of Initial Abresion | 98 | 91 | 105 | 88 | 112 | 101 | 96 |
| | at Durable Test | | | | | | | |
| | where CR is 100 | | | | | | | |
| | | | Com- | Com- | Com- | Com- | Com- | Com- |
| | | | parative | parative | parative | parative | parative | parative |
| | | Exam- | Exam- | Exam- | Exam- | Exam- | Exam- | Exam- |
| | | ple 8 | ple 1 | ple 2 | ple 3 | ple 4 | ple 5 | ple 6 |
| Polymer | Product | EP33 | EP51 | EP33 | EP33 | EP33 | EP33 | CR |
| | No. | | | | | | | |
| | or | | | | | | | |
| | Material | | | | | | | |
| | C2 | 52 | 67 | 52 | 52 | 52 | 52 | — |
| | Content | | | | | | | |
| Friction | Composition Type | A | K | I | J | K | L | — |
| Rubber | Coated Surface(s) | Inner | Both | Both | Both | Both | Both | Both |
| | Resin Content (% by mass) | 5.2 | 5.2 | 0.8 | 20.5 | 5.7 | 4.4 | — |
| | Oil Content (% by mass) | 10.4 | 10.4 | 10.9 | 8.7 | 2.3 | 24.2 | — |
| | Frictioning Characteristics | ○ | Δ | ○ | ○ | ○ | ○ | ○ |
| | Lap-joint Strength | ○ | Δ | Δ | ○ | Δ | ○ | ⊚ |
| | Covering Characteristics | ○ | × | Δ | ○ | Δ | ○ | ○ |
| Adhesive | Composition Type | A | H | A | A | A | A | — |
| Rubber | Adhisiveness to Cord | ○ | × | ○ | ○ | ○ | ○ | ○ |
| Base | Composition Type | A | H | A | A | A | A | — |
| Rubber | Ply-up Characteristics | ○ | × | ○ | ○ | ○ | ○ | ○ |
| | tan δ (100° C.) | 0.186 | 0.181 | 0.186 | 0.186 | 0.186 | 0.186 | 0.132 |
| Belt | Appearance/Size | ○ | × | × | ○ | × | ○ | ○ |
| | Life at Durable Test | 309 | | | 228 | | 245 | |
| | and Error Mode | (Crack in | — | — | (Great | — | (Great | 100 |
| | where CR is 100 | Base | | | Abresion) | | Abresion) | |
| | | Rubber) | | | | | | |
| | Degree of Initial Abresion | 67 | — | — | 131 | — | 147 | 100 |
| | at Durable Test | | | | | | | |
| | where CR is 100 | | | | | | | |

### Test and Evaluation of Belts

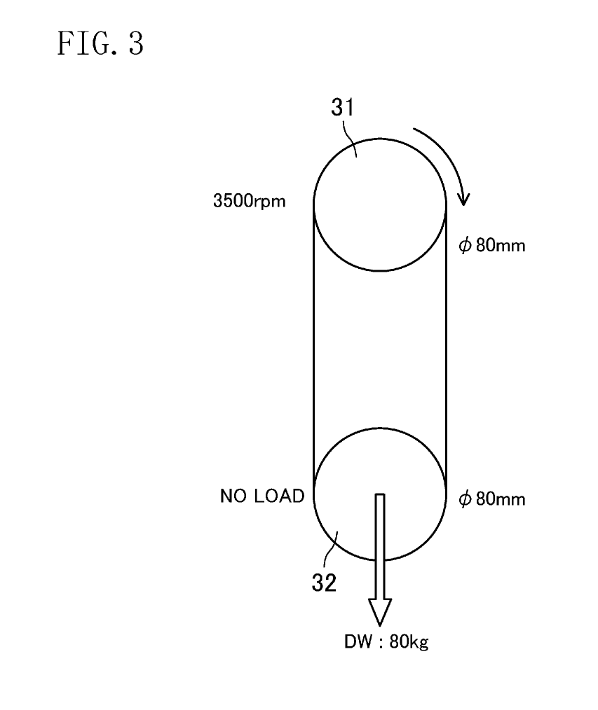

FIG. 3 illustrates the layout of pulleys for testing and evaluating belts. A driving pulley 31 had a diameter of 80 mm. A driven pulley 32 had a diameter of 80 mm and was located below the driving pulley 31. The belts to be evaluated were wrapped around these pulleys. With a dead weight of 80 kg, the driven pulley 32 rotated at 3500 rpm with no load.

Table 3 shows lives of the wrapped V-belts according to Examples 1-8 and Comparative Examples 1-6 relative to 100 of Comparative Example 6 (i.e., a chloroprene belt). As a life, the time until occurrence of a crack in the base rubber layer 11 (error mode: “crack in base rubber”) or a certain amount of abrasion (error mode: “great abrasion”) after running each belt was measured. The degree of initial abrasion in each durability test is also indicated relative to 100 of Comparative Example 6. The degree of initial abrasion in each durability test is reduction in the mass amount of a belt after 48 hours from the start of running the belt, and represented by percentage.

Table 3 also shows the frictioning characteristics, lap joint strength, and covering characteristics of each friction rubber; the adhesiveness of each adhesive rubber to the associated cord; and the ply-up characteristics and tan δ (at 100° C.) value of each base rubber.

In frictioning with a calendar, a canvas passes between two rolls with one roll wrapped with rubber so that part of the rubber is rubbed into the canvas. The workability in this frictioning is referred to as “frictioning characteristics.” Low frictioning characteristics cause transfer of all the rubber onto the canvas, which is like topping.

Bias cut canvases are jointed as follows. The canvases are lapped to have a thickness of several mm, jointed due to the adhesiveness of the friction rubber, and rolled up. The workability in this lap joint is referred to as “lap joint strength.” Low lap joint strength causes problems such as insufficient joint or partial pealing before the canvases are rolled up. In the wrapping shown in FIG. 2F, the canvas used for wrapping is not be removed due to its adhesiveness. This workability is referred to as “covering characteristics.” Low covering characteristics cause problems such as pealing of the canvas.

The adhesiveness in wrapping shown in FIG. 2A is referred to as “ply-up characteristics.” Low ply-up characteristics cause problems such as pealing during the step of FIG. 2A or, if not, in a subsequent step such as FIG. 2D or 2E.

### Result of Evaluation

With respect to the wrapped V-belts according to Examples 1-8, the friction rubber had high workability, the adhesive had high adhesiveness to the cord, and the base rubber had excellent ply-up characteristics. These high characteristics are indicated by circles in Table 3.

By contrast, Comparative Example 1 using EPDM (EP51) with an ethylene content of 67% had low workability in all respects, and low mass-productivity of belts. This may be because the high ethylene content increased the crystallinity.

Comparative Example 2 with a low resin content (specifically, 0.8% by mass) also had low workability and did not function as a belt. Example 2 with a resin content of 1.1% had high workability and functioned as a belt.

Comparative Example 3 with a high resin content (specifically, 20.5% by mass) had high workability but low resistance to abrasion. For example, the lives of Examples 1 and 3 with resin contents of 5.2% by mass and 18.8% by mass at a durability test were 320 and 287, respectively. On the other hand, the life of Comparative Example 3 at the durability test was 228. While the degrees of initial abrasion of Examples 1 and 3 at the durability test were 98 and 105, respectively, the degree of initial abrasion of Comparative Example 3 at the durability test was 131.

Comparative Example 4 with a low oil content (2.3% by mass) had low workability and did not function as a belt. Example 4 with an oil content of 3.4% by mass functioned as a belt. The life and degree of initial abrasion at the durability test of Example 4 were 311 and 88, respectively. That is, Example 4 had high resistance to abrasion.

Comparative Example 5 with a high oil content (24.2% by mass) had high workability but low resistance to abrasion. For example, while the lives of Examples 1 and 5 with oil contents 10.4% by mass and 22.5% by mass at the durability test were 320 and 282, respectively, the life of Comparative Example 5 at the durability test was 245. While the degrees of initial abrasion of Examples 1 and 5 at the durability test were 98 and 112, respectively, the degree of initial abrasion of Comparative Example 5 at the durability test was 147.

Examples 6 and 7 using devulcanized rubber as the rubber component had high workability, and high resistance to abrasion. In particular, while the life of Example 1 at the durability test was 320, which was the longest among Examples 1-5 and 8 using EP33 as the rubber composition, the lives of Examples 6 and 7 at the durability test were 414 and 425, respectively, which were much longer. The degrees of initial abrasion of Examples 6 and 7 at the durability test were 101 and 96, respectively, which were almost equal to that of the case where EP33 was used as the rubber component.

Example 7 using devulcanized rubber containing a fiber component had a higher resistance to abrasion than Example 6 containing no fiber component. This may be because the fiber component contained in the vulcanized rubber as the material melts to function as a reinforcing material of rubber.

While the ply-up characteristics of the base rubber of Examples 1-5 using the rubber composition A were 0.186, the ply-up characteristics of Examples 6 and 7 using the rubber compositions F and G containing devulcanized reclaimed rubber were 0.107 and 0.096, respectively, which were much lower than those of Examples 1-5. This is also lower than 0.132 of Comparative Example 6 using chloroprene.

In Example 8, the same rubber composition was used as Example 1, but only the inner surface of the reinforcing cloth was coated with friction rubber. The life of Example 8, which was 309, was slightly shorter than that of Example 1. However, the degree of initial abrasion of Example 8 at the durability test, which was 67, was much smaller than that of Example 1. It is clear that the resistance to abrasion increased because the outer surface of the reinforcing cloth was not coated with rubber.

As can be seen from the foregoing, the crystallinity of the polymer component of the rubber composition used for forming a belt is reduced by setting the ethylene content, which improves the workability as the belt. The oil and resin contents particularly in the friction rubber for coating the reinforcing cloth, which is on the surface(s) of the belt, are set to increase both the workability and resistance to abrasion.

The resistance to abrasion is further increased by using devulcanized rubber, which has been obtained for reclaim by devulcanizing vulcanized rubber (particularly, vulcanized rubber containing a fiber component).

In addition, only the inner surface of the reinforcing cloth is coated with rubber to further improve the resistance to abrasion.

### Second Experiment

A second experiment will now be described. Rubber compositions M-S containing vulcanized rubber powder were prepared for the base rubber layer 11. With the use of these rubber compositions, wrapped V-belts according to Examples 9-11 and Comparative Examples 6-9 were fabricated. Furthermore, a typical wrapped V-belt made of chloroprene was prepared as Comparative Example 11.

### Rubber Composition

Table 4 shows the amounts of ingredients of the rubber compositions M-S used for the base rubber layer 11.

### Rubber Composition M

As the rubber component, 100 parts by mass of EP33 with an ethylene content of 52% by mass, which was the same as the rubber composition A, and 60 parts by mass of vulcanized rubber powder containing 50% by mass of EPDM were used. On the other hand, the amounts of the compounding ingredients were as follows. The amount of HAF carbon black (e.g., Seast 3 manufactured by Tokai Carbon Co., Ltd.) was 50 parts by mass. The amount of stearic acid (e.g., stearic acid beads Tsubaki manufactured by NOF Corporation) was 1 parts by mass. The amount of zinc oxide (e.g., zinc oxide No. 3 manufactured by Sakai Chemical Industry Co., Ltd.) was 5 parts by mass. The amount of a resin component (e.g., Quintone A100 manufactured by Nippon Zeon Co., Ltd.) was 10 parts by mass. The amount of oil (e.g., Diana Process PW-90 manufactured by Idemitsu Kosan Co., Ltd.) was 20 parts by mass. The amount of organic peroxide (e.g., perbutyl P-40 manufactured by NOF Corporation with purity of 40% by mass) as a crosslinker was 5 parts by mass, in which the amount of an effective component was 2 parts by mass. The amount of a co-crosslinker (e.g., SUN-ESTAR TMP manufactured by Sanshin Chemical Industry Co., Ltd.) was 5 parts by mass. As a result of kneading these ingredients, the rubber composition M of Table 4 was obtained.

The organic peroxide used in this experiment was liquid at room temperature.

The vulcanized rubber powder in this experiment was rubber powder left after cutting cross-linked rubber in manufacturing power transmission belts. The particle size of the vulcanized rubber powder ranged from about 10 to 500 μm. After kneading, the aggregate became finer with a particle size ranging from about 1 to 200 μm.

### Rubber Composition N

Among the ingredients of the rubber composition M, only the amount of co-crosslinker was reduced from 5 to 2 parts by mass. As a result of kneading these ingredients, the rubber composition N of Table 4 was obtained.

### Rubber Composition O

Among the ingredients of the rubber composition M, only the amount of co-crosslinker was increased from 5 to 20 parts by mass. As a result of kneading these ingredients, the rubber composition O of Table 4 was obtained.

### Rubber Composition P

Among the ingredients of the rubber composition M, only the amount of co-crosslinker was reduced to 0 parts by mass (i.e., no co-crosslinker was added). As a result of kneading these ingredients, the rubber composition P of Table 4 was obtained.

### Rubber Composition Q

Among the ingredients of the rubber composition M, only the amount of co-crosslinker was increased from 5 to 25 parts by mass. As a result of kneading these ingredients, the rubber composition Q of Table 4 was obtained.

### Rubber Composition R

Among the ingredients of the rubber composition M, SUN-ESTAR TMP as the co-crosslinker was replaced with 5 parts by mass of zinc dimethacrylate (e.g., Actor ZMA manufactured by Kawaguchi Chemical Industry Co., LTD.). As a result of kneading these ingredients, the rubber composition R of Table 4 was obtained.

The zinc dimethacrylate was solid (powder) at room temperature.

### Rubber Composition S

Among the ingredients of the rubber composition M, the crosslinking system was changed to sulfur. Specifically, organic peroxide and the co-crosslinker were, like the composition A, replaced with 3 parts by mass of sulfur (e.g., sulfur for oil treatment manufactured by Karuizawa Seirensho), 2 parts by mass of an accelerator 1, which is a thiuram-based compound vulcanization accelerator (e.g., Nocceler TET manufactured by Ouchi Shinko Chemical Industrial Co., Ltd.), and 1 parts by mass of an accelerator 2, which is a thiazole-based vulcanization accelerator (e.g., DM-P manufactured by Ouchi Shinko Chemical Industrial Co., Ltd.). As a result of kneading these ingredients, the composition S of Table 4 was obtained.

TABLE 4

| | Examples | | | Comparative Examples | | | |
|---|---|---|---|---|---|---|---|
| Rubber Composition | M | N | O | P | Q | R | S |
| Kind of Polymer | EPDM | EPDM | EPDM | EPDM | EPDM | EPDM | EPDM |
| Amount | 100 | 100 | 100 | 100 | 100 | 100 | 100 |
| Rubber Powder | 60 | 60 | 60 | 60 | 60 | 60 | 60 |
| Cross-Linking System | PO | PO | PO | PO | PO | PO | S |
| Amount | 5 | 5 | 5 | 5 | 5 | 5 | 3 |
| Kind of Co-Crosslinker | TMP | TMP | TMP | — | TMP | MAAZn | — |
| Amount | 5 | 2 | 20 | 0 | 25 | 5 | — |
| HAF Carbon Black | 50 | 50 | 50 | 50 | 50 | 50 | 50 |
| Stearic Acid | 1 | 1 | 1 | 1 | 1 | 1 | 1 |
| Zinc Oxide | 5 | 5 | 5 | 5 | 5 | 5 | 5 |
| Resin | 10 | 10 | 10 | 10 | 10 | 10 | 10 |
| Oil | 20 | 20 | 20 | 20 | 20 | 20 | 20 |
| Accelerator 1 | — | — | — | — | — | — | 2 |
| Accelerator 2 | — | — | — | — | — | — | 1 |
| Sum | 256 | 253 | 271 | 251 | 276 | 256 | 252 |

### Fabrication of Wrapped V-Belt

Wrapped V-belts according to Examples 9-11 and Comparative Examples 7-10 were fabricated as shown in FIGS. 2A-2F using any one of the rubber compositions M-S as the base rubber layer 11 as shown in Table 5. The adhesive rubber layer 12 and friction rubber of each belt were made of a rubber composition formed in the same manner as the rubber composition of the base rubber layer 11 but contained no vulcanized rubber powder. As Comparative Example 11, a typical wrapped V-belt made of chloroprene rubber was prepared. In each case, both surfaces of the reinforcing cloth 15 were coated with friction rubber.

TABLE 5

| | | Examples | | | Comparative Examples | | | | |
|---|---|---|---|---|---|---|---|---|---|
| | | 9 | 10 | 11 | 7 | 8 | 9 | 10 | 11 |
| Rubber Composition | | M | N | O | P | Q | R | S | Chloroprene |
| Base | Ply-up | ○ | ○ | ○ | × | × | × | × | ○ |
| Rubber | Characteristics | | | | | Much | | | |
| | | | | | | Bleed | | | |
| | Tan δ | 0.179 | 0.182 | 0.172 | 0.201 | 0.175 | 0.173 | 0.215 | 0.132 |
| Belt | Transmission | 0.91 | 0.99 | 0.96 | 1.05 | 0.95 | 0.92 | 1.38 | 1 |
| | Efficiency | | | | | | | | |
| | Life | 331 | 359 | 223 | 205 | 214 | 318 | 210 | 100 |

### Test and Evaluation

Table 5 shows a result of evaluation of the base rubber and the belts.

The tan δ values, ply-up characteristics, and lives of the belts at a durability test were evaluated in the same manner as the first experiment. The power transmission efficiencies of the belts are indicated by values relative to a CR slip ratio of 1 at a reference power transmission capacity.

### Result of Evaluation

Table 5 shows a result of evaluation of the base rubber and the belts.

The wrapped V-belts of Example 9-11 using organic peroxide as the crosslinking system, and TMP (in amounts of 5, 2 and 20 parts by mass, respectively), which was liquid at room temperature, as the co-crosslinker had excellent ply-up characteristics. By contrast, Comparative Example 10 using sulfur as the crosslinking system, and Comparative Example 9 using organic peroxide as the crosslinking system and zinc dimethacrylate, which was solid at room temperature, as the co-crosslinker had low ply-up characteristics. Comparative Example 7 using organic peroxide as the crosslinking system but no co-crosslinker also had low ply-up characteristics.

Furthermore, Comparative Example 8 using organic peroxide as the crosslinking system, and TMP as the co-crosslinker had low ply-up characteristics. In Comparative Example 8, the amount of co-crosslinker was 25 parts by mass, which might be too much, thus causing too much bleed and lower adhesiveness. That is, there is a proper range for the co-crosslinker. For example, the range may be from 1 to 23 parts by mass per 100 parts by mass of a rubber component.

Next, the tan δ value of the rubber composition A (see Table 3) containing no cross-linked rubber powder was 0.186. The tan δ values of Examples 9-11 were 0.179, 0.182, and 0.172, respectively, which were smaller than that of the rubber composition A. The tan δ values of Comparative Example 7 using no co-crosslinker, and Comparative Example 10 using sulfur as the crosslinking system were 0.201 and 0.215, respectively. The tan δ values of Examples 9-11 were smaller than these tan δ values.

The power transmission efficiencies of the belts according to Examples 9-11 were 0.91, 0.99, and 0.96, respectively, relative to the reference power transmission capacity 1 of the slip ratio of Comparative Example 11 that was made of chloroprene rubber. These power transmission efficiencies were significantly higher than that of chloroprene and 1.05 of Comparative Example 7 using no co-crosslinker, and 1.38 of Comparative Example 10 using sulfur as the crosslinking system.

With respect to the durability, the lives of the belts according to Examples 1-3 were 331, 359, and 223, respectively, which were significantly longer than that of Comparative Example 11 where the belt was made of reference chloroprene rubber. The lives of Comparative Example 7 using EPDM but no co-crosslinker, Comparative Example 8 using 25 parts by mass of the co-crosslinker, and Comparative Example 10 using sulfur as the crosslinking system were 205, 214, and 210, respectively. The lives of Examples 9 and 10 were significantly longer than these Comparative Examples.

As can be seen from the foregoing, some of tan δ values, transmission efficiencies, and lives were excellent in Comparative Examples 1-4, ply-up characteristics were bad, which leads to low mass-productivity. By contrast, Examples 1-3 had tan δ values, power transmission efficiencies, and ply-up characteristics equal to or better than the Comparative Examples, and lives equal to or longer than the Comparative Examples at the durability test. Comparative Example 5 made of chloroprene rubber had a low tan δ value, a high power transmission efficiency, and excellent ply-up characteristics. However, the life of Comparative Example 5 was 100, which was equal to a reference value. By contrast, the lives of the Examples 1-3 were twice, or three or more times as long as that of Comparative Example 5.

In this manner, with the use of organic peroxide as the crosslinking system, and a moderate amount of co-crosslinker, which is liquid at room temperature, the rubber composition as a whole had a low tan δ value, a high power transmission efficiency, and excellent ply-up characteristics, and a long life at the durability test. The vulcanized rubber powder can be reclaimed without being devulcanized. This results in lower-cost manufacturing of a power transmission belt.

The wrapped V-belt according to the present disclosure has high resistance to abrasion and high workability, and is thus useful as a power transmission belt for various types of general industrial machines.

What is claimed is:

1. A wrapped V-belt wrapped around a pulley to transmit power, the wrapped V-belt comprising:
a belt body; and
a reinforcing cloth wrapping the belt body, wherein
at least part of the belt body is made of a rubber composition containing ethylene-α-olefin elastomer as a polymer component, and
the polymer component contains the ethylene-α-olefin elastomer within a range of 30 to 100% by mass, in which an ethylene content falls within a range of 40 to 56% by mass.

2. The wrapped V-belt of claim 1, wherein
at least one surface of the reinforcing cloth is coated with the rubber composition containing a resin component within a range of 1 to 20% by mass and oil within a range of 3 to 24% by mass.

3. The wrapped V-belt of claim 1, wherein
the belt body includes a base rubber layer on a side closer to a contact with the pulley, and
the base rubber layer is made of the rubber composition containing devulcanized reclaimed ethylene propylene diene rubber.

4. The wrapped V-belt of claim 3, wherein
devulcanization of vulcanized rubber containing a fiber component melts the fiber component so that the devulcanized reclaimed ethylene propylene diene rubber serves as a material reinforcing the rubber composition.

5. The wrapped V-belt of claim 1, wherein
the belt body includes a base rubber layer on a side closer to a contact with the pulley, and
the base rubber layer is made of the rubber composition containing kneaded vulcanized rubber powder.

6. The wrapped V-belt of claim 1, wherein
at least a surface of the reinforcing cloth, which serves as an outer surface of the belt, is not subjected to rubber treatment.
